(19) United States
(12) Patent Application Publication
(10) Pub. No.: US 2026/0149649 A1
(43) Pub. Date: May 28, 2026

(54) Sampling and Capturing CPU-Bound Packets

(71) Applicant: Arista Networks, Inc., Santa Clara, CA (US)

(72) Inventors: Sharad BIRMIWAL, Burnaby (CA); Nicholas Tsz Wang TAN, Vancouver (CA); Conor MURPHY, Burnaby (CA)

(21) Appl. No.: 18/956,640

(22) Filed: Nov. 22, 2024

(51) Int. Cl. H04L 43/022; H04L 43/04; H04L 47/10

(52) U.S. Cl. CPC H04L 43/022; H04L 43/04; H04L 47/13

(57) ABSTRACT

Techniques for sampling and capturing central processing unit (CPU)-bound packets in a network device are provided. In one set of embodiments, the network device can receive a command to enable packet sampling for a class of network traffic, where the command specifies one or more sampling parameters. The network device can identify at least one CPU queue in a plurality of CPU queues of the network device to which the class of network traffic is mapped. The network device can then configure a driver of an operating system (OS) of the network device to begin sampling packets from said at least one CPU queue in accordance with the one or more sampling parameters.

### BACKGROUND

In a network device like a switch or router, incoming network packets may be forwarded to the network device's central processing unit (CPU) for various reasons including Address Resolution Protocol (ARP) resolution, time-to-live (TTL) expiry handling, control plane protocol (e.g., Border Gateway Protocol (BGP), Spanning Tree Protocol (STP), etc.) processing, and so on. Such network packets are referred to herein as CPU-bound packets. CPU-bound packets are typically placed in hardware queues, known as CPU queues, in the network device's data plane before they are sent to the CPU. In some scenarios these CPU queues may become congested, which can cause CPU-bound traffic to be dropped.

### BRIEF DESCRIPTION OF THE DRAWINGS

With respect to the discussion to follow and in particular to the drawings, it is stressed that the particulars shown represent examples for purposes of illustrative discussion and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts an example network device in accordance with certain embodiments of the present disclosure.

FIG. 2 depicts another example network device in accordance with certain embodiments of the present disclosure.

FIG. 3 depicts a workflow for enabling packet sampling in accordance with certain embodiments of the present disclosure.

FIGS. 4A and 4B depict a packet sampling workflow in accordance with certain embodiments.

FIG. 5 depicts a packet capture workflow in accordance with certain embodiments.

### DETAILED DESCRIPTION

In the following description, for purposes of explanation, numerous examples and details are set forth in order to provide an understanding of embodiments of the present disclosure. Particular embodiments as expressed in the claims may include some or all of the features in these examples, alone or in combination with other features described below, and may further include modifications and equivalents of the features and concepts described herein.

Embodiments of the present disclosure are directed to techniques for sampling and capturing CPU-bound packets that are temporarily held in the CPU queues of a network device. With these techniques, network administrators and users can more easily triage and resolve CPU queue congestion events that occur on the device.

### 1. Example Network Device

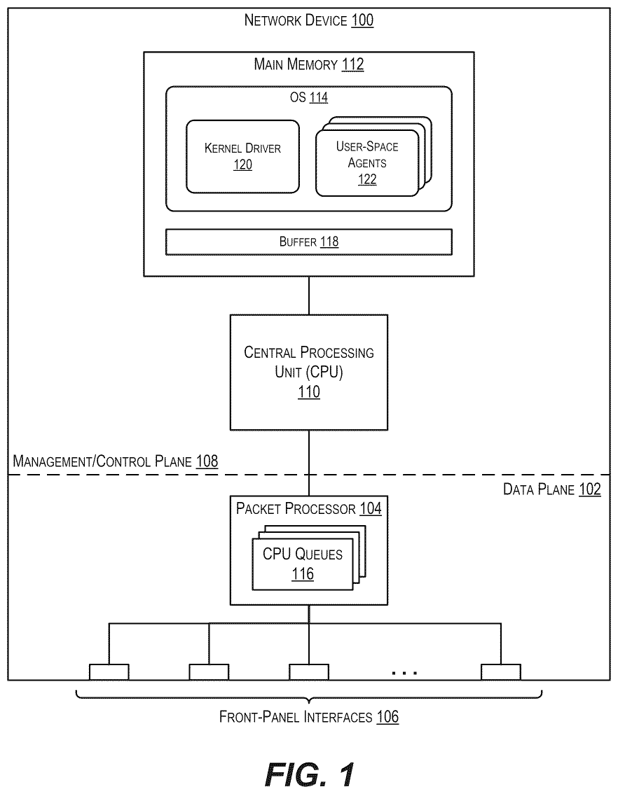

FIG. 1 is a simplified block diagram of a network device (e.g., switch, router, etc.) 100 in which the techniques of the present disclosure may be implemented. As shown, network device 100 comprises a data plane 102 including a packet processor 104 and a set of front-panel interfaces (i.e., ports) 106. Packet processor 104 is typically an integrated circuit, such as an application-specific integrated circuit (ASIC) or a field-programmable gate array (FPGA), that is responsible for performing line-speed processing of network packets (i.e., traffic) that pass through network device 100 via front-panel interfaces 106. This line-speed processing can include, for example, Layer 2 (L 2) forwarding and Layer 3(L 3 ) routing of network traffic.

Network device 100 also comprises a management/control plane 108 that includes a central processing unit (CPU) 110 and a main memory (e.g., random-access memory or RAM) 112. CPU 110 is a general-purpose processor that is responsible for managing the configuration/operation of network device 100 and controlling the device's understanding of the network in which it resides. CPU 110 carries out these functions under the direction of an operating system (OS) 114 that runs on CPU 110 from main memory 112.

As noted in the Background section, some network packets that enter network device via front-panel interfaces 106 may be forwarded from data plane 102 to management/control plane 108 for handling by CPU 110 (rather than being processed solely in the data plane using packet processor 104). Examples of such CPU-bound traffic include packets that require ARP resolution (which involves mapping an Internet Protocol (IP) address to a corresponding Media Access Control (MAC) address), packets with a TTL value of zero (which requires CPU 110 to determine how to handle this “TTL expiry”), packets that require control plane protocol (e.g., BGP, STP, etc.) processing, and so on. The following is a typical workflow that is carried out by network device 100 for processing a CPU-bound packet P that is received on an ingress front-panel interface IF:
1. Packet Processor 104 Receives Packet P From Interface If
2. Packet processor 104 determines that the routed destination for packet P is CPU 110 (or in other words, that P should be handled by CPU 110)
3. Packet processor 104 adds a metadata header to packet P that includes, among other things, a destination port corresponding to CPU 110, a CPU code (also known as a trap code) indicating the reason why P is being sent to CPU 110, and an interface ID identifying front-panel interface IF (i.e., the interface on which P was originally received)
4. Packet processor 104 adds packet P to one of multiple CPU queues (shown via reference numeral 116 in FIG. 1), where each CPU queue 116 is mapped to a traffic class (e.g., ARP packets, BGP packets, STP packets, etc.) and where P is added to the CPU queue for the traffic class to which P belongs
5. A component of data plane 102 (e.g., packet processor 104 or some other component) transfers packet P from its CPU queue 116 to a buffer 118 held in main memory 112; this may be performed via a Direct Memory Access (DMA) transfer or other mechanism
6. A kernel driver 120 of OS 114 reads packet P from buffer 118, removes the metadata header, and sends P to a virtual kernel interface IF′ that is associated with front-panel interface IF
7. One of a plurality of user-space agents 122 of OS 114 that is configured to listen on virtual kernel interface IF′ receives packet P from IF′ and processes the packet accordingly (for example, if P is a BGP packet, it is received and processed by a user-space BGP agent)

One issue with the workflow above is that one or more of CPU queues 116 may become congested, which means the rate at which CPU-bound packets are added to the CPU queues exceeds the rate at which they are removed (thereby causing the CPU queues to reach their capacities/overflow). For example, if there is a network misconfiguration where two or more devices are configured with the same IP address, network device 100 may receive a flood of ARP request packets in order to resolve the IP address, which in turn will cause the CPU queue assigned to hold ARP traffic to become congested. This is problematic because other devices/applications that require ARP resolution on network device 100 may have their ARP traffic dropped due to the congestion.

There are existing software tools such as Arista Networks' Latency Analyzer (LANZ) that can monitor the congestion levels of CPU queues 116 and generate a notification when congestion on a particular CPU queue is detected. However, these existing tools are generally limited to reporting the CPU queue that is congested and its congestion level; they provide no insight on the origin or content of the network packets held in the congested CPU queue, which are important for triaging and determining the cause of the congestion.

In addition, there are existing packet sampling solutions such as sFlow that can sample incoming packets at a network device and send the sampled packets to an external destination (or to the device's control plane) for evaluation. However, these existing sampling solutions are generally designed to indiscriminately sample all incoming traffic; accordingly, they are not useful for triaging and resolving CPU queue congestion events because they cannot narrow down the sampled packets to those that actually contribute to the congestion of a particular CPU queue.

### 2. Solution Overview

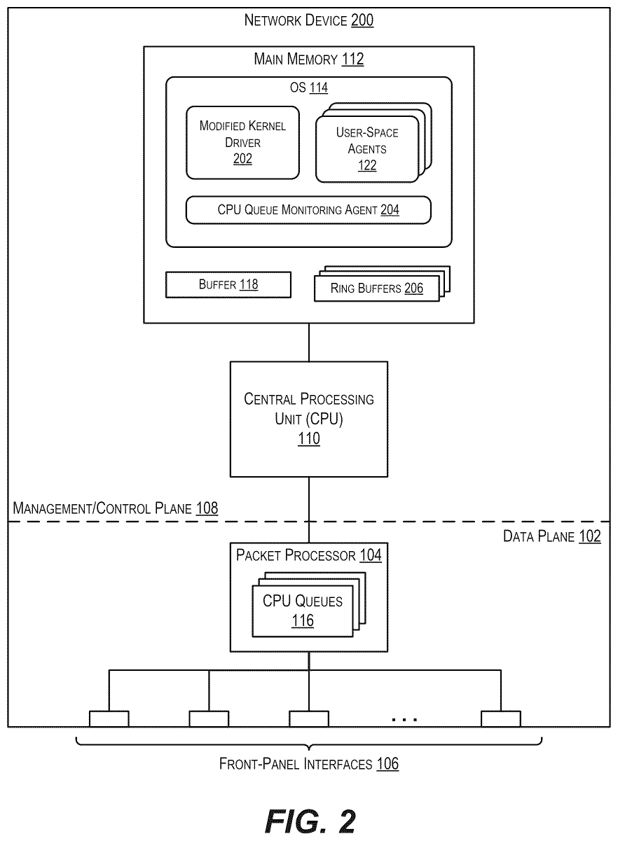

To address the foregoing and other similar problems, FIG. 2 depicts an enhanced version 200 of network device 100 that implements a novel packet sampling and capture (PSC) framework according to certain embodiments. This PSC framework includes a modified kernel driver 202 (in place of kernel driver 120 of FIG. 1), a CPU queue monitoring agent 204, and a set of ring buffers 206 in main memory 112 (e.g., one ring buffer per CPU queue 116). A ring buffer is a fixed-size memory buffer that is designed to overwrite the oldest data in the buffer with new data when the buffer has reached its capacity. In FIG. 2, modified kernel driver 202 and CPU queue monitoring agent 204 are shown as being part of OS 114 and thus are embodied in software (i.e., program code) that is executable by a processor of network device 200, such as CPU 110. In a particular embodiment, modified kernel driver 202 runs in a kernel space of OS 114 (which is a memory area where core, privileged portions of the OS operate) and CPU queue monitoring agent 204 runs in a user space of OS 114 (which is a memory area where user applications and processes run). In alternative embodiments, some or all of the functionality attributed to components 202 and 204 may be implemented partially or entirely in hardware.

At a high level, the PSC framework enables administrators, users, and other entities to sample and capture CPU-bound packets on network device 200 on a per-traffic class (and thus, per-CPU queue) basis. For example, in one set of embodiments a user of network device 200 can turn on packet sampling for one or more traffic classes such as ARP traffic, BGP traffic, etc., which causes modified kernel driver 202 to sample (i.e., select) CPU-bound packets from the CPU queue 116 mapped to each such traffic class and place the sampled packets in a corresponding ring buffer 206. While this sampling is being performed in the background, the user can enter a command to capture all sampled packets for a particular traffic class T; in response, CPU queue monitoring agent 204 can capture the contents (i.e., sampled packet data) of the ring buffer corresponding to traffic class T and can write the contents to a Packet Capture (PCAP) file and/or export those contents to an external destination (using, e.g., sFlow).

Alternatively or in addition, CPU queue monitoring agent 204 can listen for notifications from an existing congestion monitoring tool such as LANZ indicating that one or more CPU queues 116 have become congested. Upon receiving such a notification, CPU queue monitoring agent 204 can automatically capture the contents of the ring buffer(s) corresponding to the congested CPU queue(s) and persist and/or export the contents.

With this general framework and approach, a number of benefits are realized. First, by allowing users to enable packet sampling for specific traffic classes (and thus, from specific CPU queues), the users can precisely capture and examine the CPU-bound packets from a congested CPU queue and thus more easily triage and resolve congestion problems. Second, by automatically capturing the ring buffer contents for a CPU queue at the time the queue is detected as being congested, the framework can ensure that users have access to the most relevant sampled packet data for congestion triaging and remediation, without requiring the users to explicitly initiate the packet capture. Third, by employing ring buffers to hold the sampled packets, the framework can efficiently capture all CPU-bound packets that were sampled in a time window leading up to and following a detected CPU queue congestion event.

The remaining sections of the present disclosure provide additional details regarding the operation of the PSC framework according to certain embodiments, including packet sampling and capture workflows performed by modified kernel driver 202 and CPU queue monitoring agent 204. It should be appreciated that FIGS. 1 and 2 and the foregoing high-level solution description are illustrative and not intended to limit embodiments of the present disclosure. For example, although FIG. 2 depicts a particular arrangement of framework components in network device 200, other arrangements are possible (e.g., the functionality attributed to a particular component may be split into multiple components, components may be combined, etc.). One of ordinary skill in the art will recognize other similar modifications, variations, and alternatives.

### 3. Enabling Packet Sampling

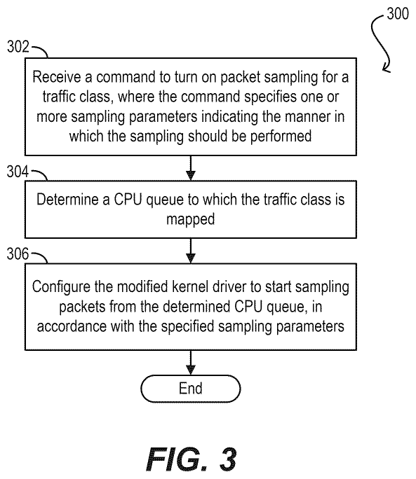

FIG. 3 depicts a workflow 300 that can be executed by CPU queue monitoring agent 204 of network device 200 for enabling (i.e., turning on) the packet sampling feature of the PSC framework according to certain embodiments. Once enabled, this packet sampling may be performed as a background task while network device 200 operates as normal.

Starting with step 302, CPU queue monitoring agent 204 can receive a command to turn on packet sampling for a traffic class, where the command specifies one or more sampling parameters indicating the manner in which the sampling should be performed. The sampling parameters can include information on how the sampling is to be performed (e.g., sample every Nth packet, statistically sample one in every N packets, or sample up to N packets every second), a sample size, an ingress interface 106 from which the sampled packets should be taken, a CPU code for which the sampling applies, and so on. In one set of embodiments, the command may be submitted by an administrator or user of network device 200 via a command line interface (CLI) or another user interface exposed by the device. In other embodiments, the command may be submitted by an automated agent in a programmatic fashion, such as by a remote network management system that submits the command via an application programming interface (API) call.

At step 304, CPU queue monitoring agent 204 can determine a CPU queue 116 to which the traffic class specified in the command is mapped. CPU queue monitoring agent 204 can then configure modified kernel driver 202 (via, e.g., an IOCTL command or other similar mechanism) to start sampling packets that originate from the determined CPU queue, in accordance with the specified sampling parameters (step 306).

### 4. Packet Sampling Workflow

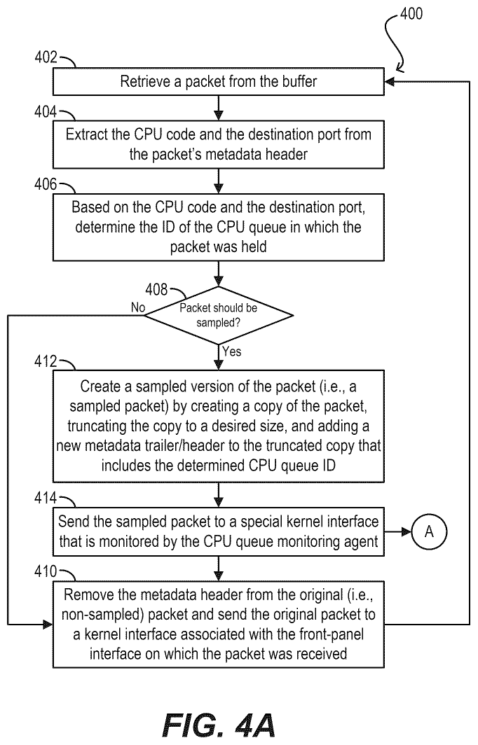

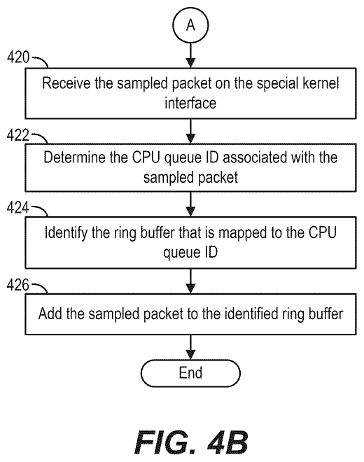

FIGS. 4A and 4B depict a workflow 400 that can be executed by modified kernel driver 202 and CPU queue monitoring agent 204 of network device 200 respectively for sampling CPU-bound packets according to certain embodiments. Workflow 400 assumes that packet sampling has been enabled on network device 200 for one or more traffic classes per workflow 300 of FIG. 3.

Starting with step 402 of FIG. 4A, modified kernel driver 202 can retrieve a packet from buffer 118. As mentioned previously, buffer 118 holds CPU-bound packets that have been transferred from CPU queues 116 of packet processor 104 to main memory 112 (via, e.g., DMA) for processing by CPU 110.

At step 404, modified kernel driver 202 can extract the CPU code and the destination port of the packet from the packet's metadata header. Based on the CPU code and the destination port, modified kernel driver 202 can determine an identifier (ID) of the CPU queue in which the packet was held (step 406).

At step 408, modified kernel driver 202 can determine whether the packet should be sampled. The driver can make this determination based on whether sampling has been turned on for the traffic class to which the packet belongs and, if so, whether the packet meets the sampling parameters specified in the command submitted to turn on the sampling. If the answer is no, modified kernel driver 202 can process the packet in accordance with step 6 of the conventional workflow discussed in section (1) above (i.e., remove the metadata header and send the packet to a virtual kernel interface associated with the front-panel interface on which the packet was originally received) (step 410). Workflow 400 can then return to step 402 so that the driver can retrieve and process the next packet in buffer 118.

However, if the answer at step 408 is yes (i.e., the packet should be sampled), modified kernel driver 202 can additionally create a sampled version of the packet, referred to as the “sampled packet,” by creating a copy of the packet, truncating the copy to a desired size, and adding a new metadata trailer or header to the truncated copy that includes the CPU queue ID determined at step 406 (step 412). Modified kernel driver 202 can then send the sampled packet to a special kernel interface that is monitored by CPU queue monitoring agent 204 (step 414). In some embodiments, there may be a single special kernel interface for all CPU queues 116; in these embodiments, modified kernel driver 202 will send all sampled packets to this single kernel interface. In other embodiments, there may be a separate special kernel interface for each CPU queue; in these embodiments, modified kernel driver 202 will send the sampled packets associated with a particular CPU queue ID to the special kernel interface for that CPU queue ID.

Turning now to FIG. 4B, at step 420, CPU queue monitoring agent 204 can receive the sampled packet on the special kernel interface. CPU queue monitoring agent 204 can then determine the CPU queue ID associated with the packet, either by extracting the CPU queue ID from the metadata trailer/header added by modified kernel driver 202 at step 416 or by deriving the CPU queue ID from the ID of the special kernel interface on which the sampled packet was received (step 422). Finally, CPU queue monitoring agent 204 can identify a ring buffer 206 that is mapped to the CPU queue ID (step 424) and can add the sampled packet to the identified ring buffer (step 426).

### 5. Packet Capture Workflow

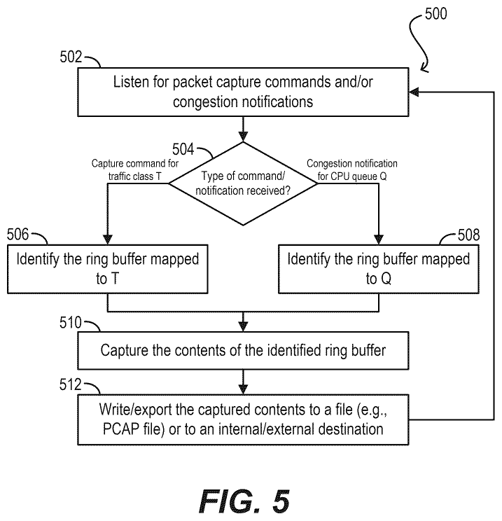

FIG. 5 depicts a workflow 500 that can be executed by CPU queue monitoring agent 204 of network device 200 for capturing sampled packets from a ring buffer 206 according to certain embodiments. Workflow 500 assumes that packet sampling has been enabled on network device 200 for one or more traffic classes per workflow 300 of FIG. 3 and that one or more ring buffers 206 have been populated with sampled packet data per workflow 400 of FIGS. 4A and 4B. In various embodiments, CPU queue monitoring agent 204 can execute workflow 500 concurrently with the steps attributed to agent 204 in workflow 400. Further, like the packet sampling process, this packet capture process can be carried out as a background task while network device 200 operates as normal.

Starting with step 502, CPU queue monitoring agent 204 can listen for explicit packet capture commands (from, e.g., an administrator/user or other entity) and/or CPU queue congestion notifications (from, e.g., an existing congestion monitoring tool like LANZ).

Upon receiving a packet capture command to capture the sampled packet data for a particular traffic class T (step 504), CPU queue monitoring agent 204 can identify the ring buffer mapped to T (step 506). Alternatively, upon receiving a CPU queue congestion notification indicating that a CPU queue Q is congested (step 504), CPU queue monitoring agent 204 can identify the ring buffer mapped to Q (step 508).

Finally, CPU queue monitoring agent 204 can capture partial or complete contents of the ring buffer identified at step 506 or 508 (step 510), write/export the captured contents to a file (e.g., PCAP file) or to some internal or external destination (step 512), and return to step 502 to continue listening for further capture commands/congestion notifications.

Although not shown in the workflow, in some embodiments CPU queue monitoring agent 204 can continue capturing new sampled packets at step 510 that are added to the identified ring buffer for some time interval after receipt of the packet capture command or congestion notification. This time interval can be configured on a per-traffic class or per-CPU queue basis on network device 200.

Further, in some embodiments the size of each ring buffer 206 can be configurable, which controls the amount of sampled packet data that can be held in the ring buffer at once. For example, a user may configure a large ring buffer size for a traffic class/CPU queue that typically requires evaluation of a large window of sampled packets (both before and after a congestion event) for congestion triaging and/or remediation purposes.

Further, in some embodiments CPU queue monitoring agent 204 can refrain from repeating workflow 500 (i.e., capturing and exporting the contents of a ring buffer) for some time period after a previous export event. This prevents agent 204 from starting another packet capture/export too soon and thus filling its storage with successive exports. This time period can be configured by a user or administrator of network device 200.

Yet further, in some embodiments CPU queue monitoring agent 204 may initiate the packet capture and export at steps 510 and 512 in response to criteria other than receiving a packet capture command or a CPU queue congestion notification. For example, in one embodiment CPU queue monitoring agent 204 can initiate the packet capture/export based on the contents of a packet that is received, such as in response to receiving an ARP packet with a specific IP address. This may be useful for debugging purposes. In this embodiment, a user or administrator can configure the packet content criteria that trigger capture/export on a per CPU queue basis or can configure common packet content criteria that apply to all CPU queues.

In another embodiment, CPU queue monitoring agent 204 may inspect the state of a ring buffer to trigger the capture and export of the contents of that ring buffer. For example, if agent 204 identifies a first packet in the ring buffer as matching a first criterion and a second packet in the ring buffer as matching a second criterion, the agent can conclude that the presence of both together indicates that the capture/export process should be initiated.

In another embodiment, CPU queue monitoring agent 204 may trigger the capture and export of the contents of a ring buffer when N packets are received in the ring buffer within a time interval. Note that this can be sooner than an actual congestion event.

### 6. Other Aspects

In some packet processor designs, the packet processor may transfer certain classes of CPU-bound traffic to the network device's main memory buffer directly, bypassing the CPU queues. For such “queue-bypass” traffic classes, there are no corresponding CPU queues in the packet processor. This means CPU queue monitoring agent 204 cannot configure modified kernel driver 202 to sample packets belonging to queue-bypass traffic classes in accordance with a CPU queue ID. To address this, CPU queue monitoring agent 204 can instead configure modified kernel driver 202 to sample queue-bypass traffic classes based on a CPU (trap) code to which those traffic classes are mapped (rather than CPU queue ID). In addition, upon sampling a packet belonging to a queue-bypass traffic class, modified kernel driver 202 can assign a predefined dummy (i.e., fake) CPU queue ID to the packet, where the dummy CPU queue ID is not associated with, and thus does not identify, any of CPU queues 116. Driver 202 can then send the sampled packet with this dummy CPU queue ID to the special kernel interface for processing by CPU queue monitoring agent 204.

Further, in some packet processor designs, the CPU queues may be replicated on a per-interface basis, such that each front-panel interface is mapped to its own set of CPU queues. For example, front-panel interface IF1 may have an ARP CPU queue and a BGP CPU queue, front-panel interface IF2 may also have an ARP CPU queue and a BGP CPU queue, and so on. In these cases, CPU queue monitoring agent 204 can configure modified kernel driver 202 to sample packets from the replicated CPU queues of a range of front-panel interfaces for a traffic class T and to send sampled packets to the special kernel interfaces using a single, consolidated CPU queue ID corresponding to T.

For example, assume a user enables packet sampling for ARP traffic on front-panel interfaces IF1-IF3, where each interface has its own ARP CPU queue. In this scenario, CPU queue monitoring agent 204 can configure modified kernel driver 202 to sample packets from the ARP CPU queues of IF1, IF2, and IF3, which are associated with a single, consolidated CPU queue ID Z. Upon sampling such packets, modified kernel driver 202 can add CPU queue ID Z to the sampled packets before sending them to the special kernel interface, which will in turn cause the sampled packets to be added to a single ring buffer mapped to Z.

The above description illustrates various embodiments of the present disclosure along with examples of how aspects of these embodiments may be implemented. The above examples and embodiments should not be deemed to be the only embodiments and are presented to illustrate the flexibility and advantages of the present disclosure as defined by the following claims. For example, although certain embodiments have been described with respect to particular workflows and steps, it should be apparent to those skilled in the art that the scope of the present disclosure is not strictly limited to the described workflows and steps. Steps described as sequential may be executed in parallel, order of steps may be varied, and steps may be modified, combined, added, or omitted. As another example, although certain embodiments may have been described using a particular combination of hardware and software, it should be recognized that other combinations of hardware and software are possible, and that specific operations described as being implemented in hardware can also be implemented in software and vice versa.

The specification and drawings are, accordingly, to be regarded in an illustrative rather than restrictive sense. Other arrangements, embodiments, implementations, and equivalents will be evident to those skilled in the art and may be employed without departing from the spirit and scope of the present disclosure as set forth in the following claims.

1. A method performed by a network device comprising a central processing unit (CPU) and a plurality of CPU queues, the method comprising:
receiving a command to enable packet sampling for a class of network traffic, the command specifying one or more sampling parameters;
identifying at least one CPU queue in the plurality of CPU queues to which the class of network traffic is mapped; and
configuring a driver of an operating system (OS) of the network device to begin sampling packets from said at least one CPU queue in accordance with the one or more sampling parameters.

2. The method of claim 1 wherein the driver runs in a kernel space of the OS.

3. The method of claim 1 wherein the receiving, the identifying, and the configuring are performed by an agent that runs in a user space of the OS.

4. The method of claim 3 wherein upon being configured, the driver:
retrieves, from a buffer in a main memory of the network device, a packet that was transferred to the buffer from one of the plurality of CPU queues;
determines a CPU queue identifier (ID) from a metadata header of the packet, the CPU queue ID identifying said at least one CPU queue;
determines whether the packet should be sampled; and
upon determining that the packet should be sampled:
creates a sampled packet from the packet by:
creating a copy of the packet;
truncating the copy; and
adding a new metadata trailer or header that includes the CPU queue ID to the truncated copy; and
sends the sampled packet to a special kernel interface monitored by the agent.

5. The method of claim 4 wherein the driver determines whether the packet should be sampled based on the one or more sampling parameters and whether the packet belongs to the traffic class.

6. The method of claim 4 wherein the agent:
receives the sampled packet on the special kernel interface;
determines the CPU queue ID;
identifies one of a plurality of ring buffers mapped to the CPU queue ID; and
adds the sampled packet to the identified ring buffer.

7. The method of claim 6 wherein the agent determines the CPU queue ID by extracting the CPU queue ID from the new metadata trailer or header of the sampled packet.

8. The method of claim 6 wherein the agent determines the CPU queue ID based on the special kernel interface on which the sampled packet is received.

9. The method of claim 6 wherein the agent further:
receives a second command to capture sampled packets for the class of network traffic; and
in response to the second command:
captures partial or complete contents of the identified ring buffer; and
writes the captured contents to a packet capture file or exports the captured contents to a destination external to the network device.

10. The method of claim 9 wherein, in addition to capturing the contents of the identified ring buffer in response to the second command, the agent captures further sampled packets added to the identified ring buffer in a configurable time window after receipt of the second command.

11. The method of claim 6 wherein the agent further:
receives a notification that the CPU queue has become congested; and
in response to the notification:
captures partial or complete contents of the identified ring buffer; and
writes the captured contents to a packet capture file or exports the captured contents to a destination external to the network device.

12. The method of claim 6 wherein a size of each ring buffer in the plurality of ring buffers is configurable by a user of the network device.

13. The method of claim 1 wherein the identifying comprises identifying multiple CPU queues associated with a range of front-panel interfaces of the network device, and
wherein the configuring comprises configuring the driver to begin sampling packets from the multiple CPU queues.

14. A network device comprising:
a central processing unit (CPU);
a packet processor including a plurality of CPU queues; and
a main memory having stored thereon program code for an agent and a driver, the agent being configured to:
receive a command to enable packet sampling for a class of network traffic, the command specifying one or more sampling parameters;
identify at least one CPU queue in the plurality of CPU queues to which the class of network traffic is mapped; and
configure the driver to begin sampling packets from said at least one CPU queue in accordance with the one or more sampling parameters.

15. The network device of claim 14 wherein upon being configured, the driver:
retrieves, from a buffer in the main memory, a packet that was transferred to the buffer from one of the plurality of CPU queues;
determines a CPU queue identifier (ID) from a metadata header of the packet, the CPU queue ID identifying said at least one CPU queue;
determines whether the packet should be sampled; and
upon determining that the packet should be sampled:
creates a sampled packet from the packet by:
creating a copy of the packet;
truncating the copy; and
adding a new metadata trailer or header that includes the CPU queue ID to the truncated copy; and
sends the sampled packet to a special kernel interface monitored by the agent.

16. The network device of claim 15 wherein the agent:
receives the sampled packet on the special kernel interface;
determines the CPU queue ID;
identifies one of a plurality of ring buffers mapped to the CPU queue ID; and
adds the sampled packet to the identified ring buffer.

17. The network device of claim 16 wherein the agent further:
receives a second command to capture sampled packets for the class of network traffic; and
in response to the second command:
captures partial or complete contents of the identified ring buffer; and
writes the captured contents to a packet capture file or exports the captured contents to a destination external to the network device.

18. The network device of claim 16 wherein the agent further:
receives a notification that the CPU queue has become congested; and
in response to the notification:
captures partial or complete contents of the identified ring buffer; and
writes the captured contents to a packet capture file or exports the captured contents to a destination external to the network device.

19. A method performed by a network device comprising a central processing unit (CPU) and a plurality of CPU queues, the method comprising:
receiving a command to enable packet sampling for a class of network traffic, the command specifying one or more sampling parameters;
identifying a CPU code to which the class of network traffic is mapped; and
configuring a driver of an operating system (OS) of the network device to begin sampling packets bound for the CPU that are associated with the trap code, in accordance with the one or more sampling parameters.

20. The method of claim 19 wherein upon being configured, the driver:
retrieves, from a buffer in a main memory of the network device, a packet transferred to the buffer, the packet belonging to the class of network traffic;
creates a sampled packet from the packet;
assigns a dummy CPU queue ID to the sampled packet, the dummy CPU queue ID not identifying any of the plurality of CPU queues; and
sends the sampled packet with the dummy CPU queue ID to a special kernel interface monitored by an agent.
